(19) United States
(12) Patent Application Publication
(10) Pub. No.: US 2008/0262897 A1
(43) Pub. Date: Oct. 23, 2008

(54) System and method for geographic location of customer services

(75) Inventors: Jamie C. Howarter, Overland Park, KS (US); Richard G. Bradford, Kansas City, MO (US)

Correspondence Address: PATTON BOGGS, LLP, 2001 ROSS AVENUE, SUITE 3000, DALLAS, TX, 75201, US

(73) Assignee: Embarq Holdings Company, LLC

(21) Appl. No.: 11/787,571

(22) Filed: Apr. 17, 2007

(51) Int. Cl. G06F 17/30

(52) U.S. Cl. 705/10

(57) ABSTRACT

A system and method for identifying potential customers for communications services. A latitude and longitude associated with an address of a potential customer is identified. The availability of the communications services are indicated based on the latitude and longitude. An availability map and services offers are displayed to the potential customer. A communication service is added for the potential customer.

### BACKGROUND

Communications services have grown nearly exponentially in recent years. The growth is fueled by improvements in technology and enhanced communications protocols. These communications services may provide social, business, educational, and economic opportunities that were unavailable just a few years ago. Communications services have become increasingly more popular based on mainstream usage, dropping service prices, and the fact that most individuals learn to use the services as part of their education.

Based on the growing dependence on communications services, many communications service providers are expanding the availability and types of services that they offer. In many cases, it is difficult for a potential customer or customer service representative (CSR) of the communications service provider to determine which services are available in the customer's geographic location.

Traditional methods of determining service availability are very rigid. As a result, potential customers are prevented from signing up for services even if the services could easily be added or extended to the customer. In other cases, potential customers are promised services only to later find that the communications service provider cannot deliver the desired services.

Typically, the determination of whether a potential customer may add a service is based on the installation of legacy systems, such as a twisted pair line for phone service or a cable connection for cable television. As new homes are built and people begin to cut cords relying exclusively on wireless communications, communications service providers are unable to accurately and efficiently determine whether a potential customer may add a service. In other cases, the address of the potential customer, relevant network distances, and access to the nearest communications node is not properly used to determine service availability. As a result, potential customers are not adequately matched to available services based on the location of the potential customer.

### SUMMARY

To provide a system and method for identifying potential customers for communications services. In one embodiment a latitude and longitude associated with an address of a potential customer may be identified. The availability of the communications services may be indicated based on the latitude and longitude. An availability map and services offers may be displayed to the potential customer. A communication service is added for the potential customer.

Another embodiment includes a server for determining availability of communications services. The server may include a memory with a set of instructions. The server may also include a processing unit for executing the set of instructions to identify a latitude and longitude associated with an address of a potential customer of a communication service provider, indicate availability of the communication services based on the latitude and longitude, display an availability map to the potential customer, and add a communication service for the potential customer.

Yet another embodiment includes a method for expanding communications resources. Multiple potential customers that are unable to receive a communication service may be identified. Latitudes and longitudes associated with the address of the multiple potential customers are identified. A location for a network device is determined that may provide the communication service to a portion of the multiple potential customers based on the latitudes and longitudes. The network device is installed to provide the communication service to the portion of the multiple potential customers. The communications services are marketed to the multiple potential customers.

### BRIEF DESCRIPTION OF THE DRAWINGS

Illustrative embodiments of the present invention are described in detail below with reference to the attached drawing figures, which are incorporated by reference herein and wherein:

FIG. 1 is an example of a system map in accordance with an illustrative embodiment of the present invention;

FIG. 2 is an exemplary national territory map in accordance with an illustrative embodiment of the present invention;

FIG. 3 is an exemplary county territory map in accordance with an illustrative embodiment of the present invention;

FIG. 4 is an exemplary city territory map in accordance with an illustrative embodiment of the present invention;

FIG. 5 is a block diagram of a geographic location system in accordance with an illustrative embodiment of the present invention;

FIG. 6A-B is a mapping graphical user interface in accordance with an illustrative embodiment of the present invention;

FIG. 7 is a flowchart of a process for geographic location through a customer service representative in accordance with an illustrative embodiment of the present invention;

FIG. 8 is a flowchart of a process for updating a geographic location system in accordance with an illustrative embodiment of the present invention; and

FIG. 9 is a flowchart of a process for geographic location through a website in accordance with an illustrative embodiment of the present invention.

### DETAILED DESCRIPTION OF THE DRAWINGS

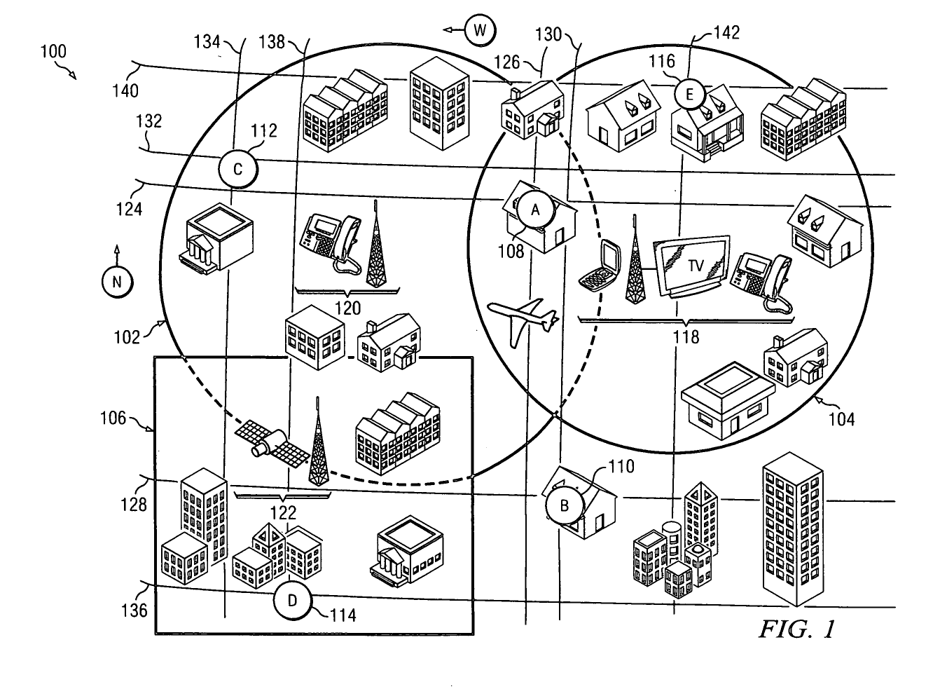

FIG. 1 is an example of a system map in accordance with an illustrative embodiment of the present invention. FIG. 1 is a system map 100 for a communications service provider. The system map 100 illustrates the different services, locations, residences, buildings, and customers served by the communications service provider. The map 100 may further illustrate geographic and man made landmarks and structures that may affect communications services. The system map includes footprints 102, 104 and 106, Customer A 108, Customer B 110, Customer C 112, Customer D 114, and Customer E 116, and services 118, 120 and 122. The system map 100 also includes latitude lines 124, 128, 132, 136, and 140 and longitude lines 126, 130 134, 138, and 142. The system map 100 shows for illustration purposes various other commercial and residential buildings as well as commercial sites, such as an airport and government offices.

The system map 100 is an example of a typical community, city, or town that receives or uses services from the communications service provider. The footprints 102, 104 and 106 represent the service area for services 120, 118 and 122, respectively. Each latitude and longitude line corresponds to a specific customer location that is typically shown as two numbers, such as (−96.799, 32.787). For example, Customer A 108 is physically located at latitude 124 and longitude 126. As a result, each latitude and longitude line or point may be used to accurately represent the physical geographic location of the customer. In the event the customer moves from location to location, the latitude and longitude point of the customer also varies accordingly.

The services 118, 120 and 122 represent the communications services provided by the communications service provider for each geographic location shown in the system map 100. The communications service provider may provide or distribute any number of services, such as wireless telephone and data services, television, standard telephone service, cable television service, IP television service, Internet service, and satellite television. In one example, footprint 102 provides services 120 which may include telephone and cellular services for Customer C 112. The system map 100 illustrates the different services 118, 120 and 122 that may be available to each customer based on the geographic location of the customer. In some cases, the customer may travel throughout the area or system map 100 during the regular course of life and/or business. However, the actual geographic locations shown for each customer illustrate the services that may be available at the customer's residence, educational, business, or other location. For example, Customer C 112 may work out of the office and, as such, may need telephone service when performing the regular aspects of his or her job.

In some cases, services may overlap based on the location of the customer. For example, Customer A 108 may have access to services 118 and services 120 based on the geographic location of Customer A 108. However, Customer B 110 may have access to none of the services 118, 120 and 122 based on the physical location of the residence of Customer B 110.

In one embodiment, the system map 100 may be displayed to a customer service representative (CSR) that works for the communications service provider using a data processing system, such as a desktop computer. The system map 100 may be used by the CSR to determine which services 118, 120 and 122 are available to the customer based on the customer's address and corresponding latitude and longitude coordinates.

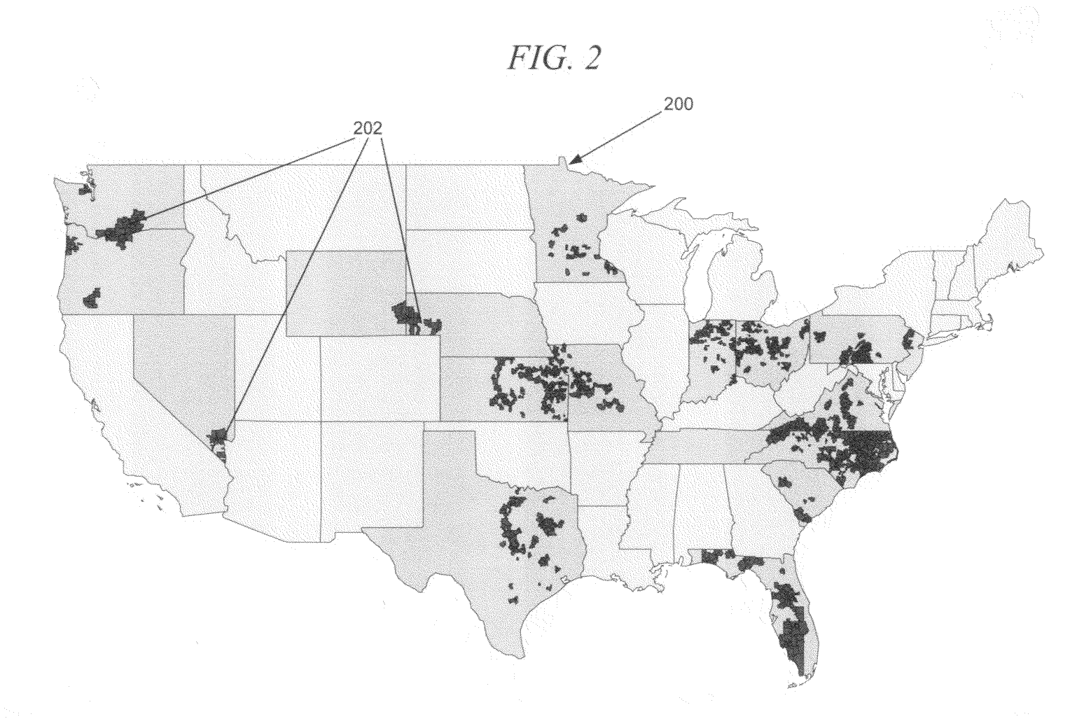

FIG. 2 is an exemplary national territory map in accordance with an illustrative embodiment of the present invention. Map 200 illustrates an example of territories within the United States covered by a particular communications service provider. Similar maps may be used to show service coverage areas for any number of countries and continents. The map 200 may be displayed as part of a graphical user interface, website, or other customer service interface.

The map 200 particularly shows service locations 202. The service locations 202 are shown as shaded areas. The service locations 202 may be the geographic areas that have access to the services provided by the communications service provider. The map 200 may use different colors to specify the services available for the service locations 202. For example, the service locations 202 may represent cellular phone, cable, satellite, IP television, broadband Internet, and other communications services. The map 200 may be updated as often as necessary to accurately represent the service locations. The map 200 may also show areas that are or may be expanded with new network resources to show proposed service locations for the services areas that will be added once the expansions are completed. The map 200 may be used as a marketing tool for customers and potential customers.

The map 200 is a high-level map that may be used to show a potential customer or CSR the areas of the United Sates in which the communications service provider offers services. For example, a potential customer from Montana may easily determine that there are no services available at the present time from communication services provider.

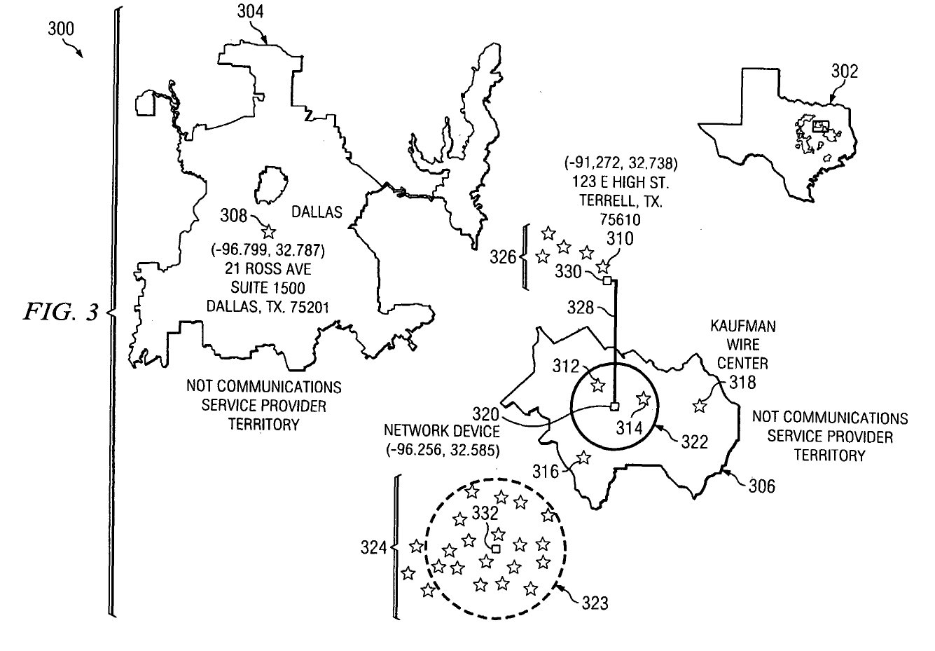

FIG. 3 is an exemplary county territory map in accordance with an illustrative embodiment of the present invention. Map 300 illustrates a portion of the territories shown in a national map, such as map 200 of FIG. 2. In one example, map 300 may be a zoomed, narrowed or county view of Texas 302 from map 200 of FIG. 2. In particular, the map 300 may show only a selected coverage area or an area including specified addresses, locations, or parameters.

Map 300 includes service locations 304 and 306, customers 308, 310, 312, 314, 316, and 318, network device 320, boundaries 322 and 323, potential customers 324 and 326, proposed line 328, and proposed devices 330 and 332. The map 300 may be displayed to a customer/potential customer or customer service representative by a server, through a program, or on the service provider's website in order to answer service availability questions. The map 300 may be displayed using a graphical user interface or as part of a program application or website. In one example, customers 308, 310, 312, 314, 316, and 318 may initiate contact with a customer service representative during a given day for adding, deleting, or modifying a communications service. The customers 308, 310, 312, 314, 316, and 318 may be current customers or potential customers

The network device 320 may be a node, switch, network device, converter, repeater, amplifier, junction, existing line, or other point that may be used to provide service to one or more of the customers 308, 310, 312, 314, 316, and 318.

Various scenarios and examples are used to further explain a few of the ways in which the map 300 may be used by the communications service provider, CSR, customer, or potential customer. Customer 308 may initiate a call and provide an address which is geocoded. The address is geocoded by determining latitude and longitude for the address provided. The latitude and longitude may be displayed on the map 300 or as part of a linked application. The geographic location system of the communications service provider may determine the customer 308 does not actively subscribe to any services and is out of the service area for high speed Internet and IP television. The customer 308 is offered a wireless phone package and accepts and begins using a cell phone in the service location 304.

Customer 310 may initiate a chat session with a customer service representative. The address of the customer 310 is geocoded and determined to be out of the service area. The customer 310 may be additionally offered information about the website and nearest retail location.

Customer 312 may call desiring to obtain a high speed Internet connection from the communications service provider. The customer 312 may already be a cellular phone customer and after a point-to-point distance and network distance is calculated a determination is made that the customer 312 may receive high-speed Internet and the service is added to the service package of the customer 312. Customer 314 may not be a current customer of the communications service provider, but upon calling a CSR is determined to have access to all available services based on the address of the customer 314. For example, the network distance and direct distance between the network device 320 and customer 312 may be used to determine availability of services using latitude and longitude measurements.

Customer 316 may call as a non-customer. Based on the address supplied by the customer 316, only some of the services offered by communications service provider are available and offered to the customer 316. Customer 318 may call as a current customer wanting to add high-speed Internet to an existing communications package. The address of the customer 318 is geocoded and a point-to-point distance and network distance is calculated using the latitude and longitude of the customer's address. The distances indicate that a network distance constraint would be violated if the service were added for customer 318. Most services provided by a telecommunications service provider include distance limitations.

For example, fiber optics, twisted pair, and cable lines have network distance limitations that may not be exceeded without significant signal loss or significant degradation. As a result, new nodes must be added to amplify or repeat the signal or expand the existing network infrastructure to accommodate the extended distances. The latitude and longitude points for the customer 316 and the nearest network device 320 are used to determine whether the customer 316 is eligible for the service. The communications service provider and customer 316 do not need to go through detailed discussions regarding service terms if the customer 316 is not going to receive the service.

In another example, wireless services, such as cellular voice and data services and WiFi may have distance limitations that are created by point-to-point distance, interference, or geographic limitations. For example, local factors may affect eligibility for service including mountains, power lines, and buildings. The communications service provider system may store latitude and longitude data regarding service and service quality for geographic areas within or out of their territory.

The embodiments of the present invention may also be used for marketing and expansion of the network infrastructure. Potential customers 324 and 326 may have previously called or contacted the communication service provider to request one or more services. The historical information stored by the communication service provider may be used to strategically expand resources to cover as many potential customers as possible. For example, communications service provider may add network device 332 to cover some of potential customers 324. The communication service provider may use the location of potential customers 324 to determine where to add a wireless WiFi broadcast tower that covers as many potential customers 324 as possible within the boundary 323.

The communication service provider system may automatically suggest network expansions based on potential customers or other rules and parameters established by the communication service provider. For example, the potential customers 324 may be in a rural area and may be extremely willing to sign up for a high-speed Internet service based on the unavailability of quality Internet services in the area. The communication service provider may be unable to cover all potential customers 324, but may expand to include as many potential customers 324 as possible based on factors, such as distance limitations, competition, and perceived interest of the potential customers 324 in an expanded service.

In one embodiment, a certain number of new customers or customer inquiries regarding a potential service, which may or may not currently be available, may be thresholded and trigger the communication provider system to automatically trigger a request for a change, or an actual order for a change, in the network. Such change may include, for example, provisioning a new resource like a new switch, wireless tower, WIFi hotspot, fiber line, or any other network device, media such as communication lines, or other network resource. Likewise, such change may include changes to the network such as adjustments in power for cell towers or hotspots, directional or positional changes to network resources, turning on previously dormant fiber, or any other suitable change to improve or otherwise alter network performance.

The communication service provider system may use the latitude and longitude points for the potential customers 332 to market new services for the potential customers 332 that will be within the boundary 323 of the new high-speed Internet service. As a result, the communication service provider may be able to more effectively market potential, new, or existing communication services. The latitude and longitude points may be used to perform efficient marketing directly only customers to potential customers 332 that fall within the network and straight-line distances supported by the service or as previously determined by the boundary 323. Such efficient marketing may include only targeting specific email addresses, business or residential physical addresses, telephone numbers, television markets, etc.

In another example of map 300, potential customers 326 which include customer 310 may have unsuccessfully previously contacted the communication service provider to request a service. The information regarding the potential customers 326 and associated longitudes and latitudes may be stored in a database. For example, once customer 310 calls requesting traditional voice service, the communications service provider system or administration may determine that a network extension is appropriate to meet the needs of new customers. Proposed line 328 and proposed network device 330 may be added to provide communication services to potential customers 326. In one example, proposed line 328 is a fiber optic line that expands the service potential of the communications service provider. Proposed network device 330 may be used to install drop lines or connections to the premises of potential customers 326 and customer 310. The communications service provider system may propose the length of the proposed line 328 and the position of proposed network device 330 in order to serve all or as many of the potential customers 326 as possible. By keeping a log of the potential customers, network expansion is more efficiently performed to maximize the numbers of new customers served while minimizing inefficient or poorly planned installation efforts.

As previously mentioned, direct marketing efforts may be made to potential customers 326 and surrounding neighbors based on previously acquired data and other longitude and latitude information. The marketing may occur before, during, or after the installation of proposed line 328 and the proposed network device 330 is completed in order to maximize profits and ensure an effective transition.

In one embodiment, the map 300 may be revised to expand the service locations 304 and 306 based on the proposed network devices 330 and 332. The map 300 with revisions or proposed modifications may be displayed in real-time to a customer, CSR, or executive of the communication service provider in order to make decisions regarding network expansions. For example, the communications service provider may determine that once a predetermined number of potential customers 324 and 326 is reached, fixed plans for adding proposed network devices 330 and 332 may be implemented. Before the changes are made, the map 300 may be modified to show proposed expansion based on the new network resources and/or a timeline for installation.

In one embodiment, the proposed placement of a new length of fiber, new cell tower, new hot spot, power adjustment to a cell tower, or other network addition or adjustment may be automatically reflected on map 300 to show the new addition or adjustment and/or the geographic footprint impacted by the change. In another embodiment, the customers falling within the impacted geographic footprint may be displayed, reported, stored, or determined. In one embodiment, customers who have generated inquiries for a requested service may be highlighted on the map 300 when an adjustment or addition would render the requested service available to the customer. In such a manner, an operator may immediately see the number of customer inquiries that would be addressed by a network adjustment or addition. In another embodiment, once a change is approved, an email, mailing or other automatic or manual notification may be initiated to the customers who have inquired letting them know that the service is available or will be available by a certain date.

A map 300 may be used to interactively determine how and when network resources should be added to best fulfill the goals and expansion of the communication service provider. The map 300 may be kept private or may be displayed publicly as a marketing tool and information tool.

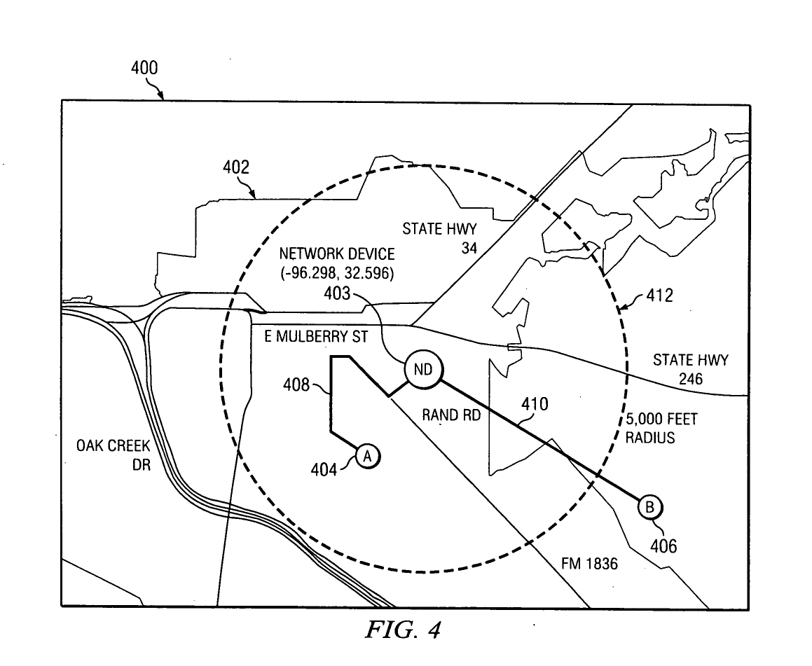

FIG. 4 is an exemplary city territory map in accordance with an illustrative embodiment of the present invention. Map 400 is another embodiment of a geographic tool for illustrating service availability of a communications service provider similar to map 300 of FIG. 3. The map 400 may display roads, geographic elements, such as mountains, lakes, and rivers, neighborhoods, and other features that make the map more easily understood. The map 400 is a zoomed in or narrow view of a coverage area 402. The map 400 may be displayed to a potential customer or CSR to better illustrate communication service availability. In particular, the map 400 may be used to illustrate a network device 403, a customer A 404, a customer B 406, a straight line distance 408, a network distance 410, and a boundary 412. In another embodiment, the map 400 may also show proposed network resources and the effect that the proposed network resources may have on the availability of services for each area within the map.

As shown in this example, customer A 404 is within the boundary 412 and has access to all of the services provided by the communications service provider. The boundary 412 may represent the service limitations of one or more services. For example, the boundary 412 may represent the distance limitations from the network device 403 which may be a boundary of approximately 5000 feet. The boundary 412 may be any shape or configuration that illustrates the limitations of a communications service. For example, customer B 406 may not be in close enough proximity to the network device 403 to be able to subscribe to the communication service available within the boundary 412.

The map 400 may illustrate various distances for each customer. For example, the straight line distance 410 between the network device 403 and the customer B 406 represents the direct point-to-point distance between the two points. The straight line distance 410 may be calculated using the latitude and longitude of the network device 403 and the customer B 406. The straight line distance 410 may be particularly useful for determining availability to wireless services from a central broadcasting device, such as WiFi® or WiMAX®.

The network distance 408 represents the actual distance that a communications service would take as buried or otherwise routed to the address of the customer. For example, a new communication service may be run through, around, or along existing right-of-ways, roads, bridges, parks, easements, alleys, in a route that is not point-to-point. The network distance 408 may be used to determine whether the customer may add a service based on a determined, calculated, or inferred network distance. In some cases, although the customer may appear to be within the boundary 412, the customer may be unable to receive a service because the determined network distance from the nearest network device 403 exceeds distance limitations. If the communications service is a wireless network or other similar service the straight line distance and network distance for each customer may be the same.

The network distance 408 may include different segments or paths of the communications line. For example, the network distance 408 may be for fiber optics which includes a customer premise segment between a splice box and the customer's home, a segment between the splice box and a central junction box, and a distance between the central junction box distance and a network device. The network distance 408 may be calculated by summing the three different segments. The network distance 408 may include any number of segments that may be combined to determine whether a network limitation is exceeded. The network distance 408 and the different segments may have distance limitations that effect whether the customer is eligible to receive applicable services. Additionally, the customer may subscribe to multiple services each of which may have a different network distance that may be calculated to determine service eligibility.

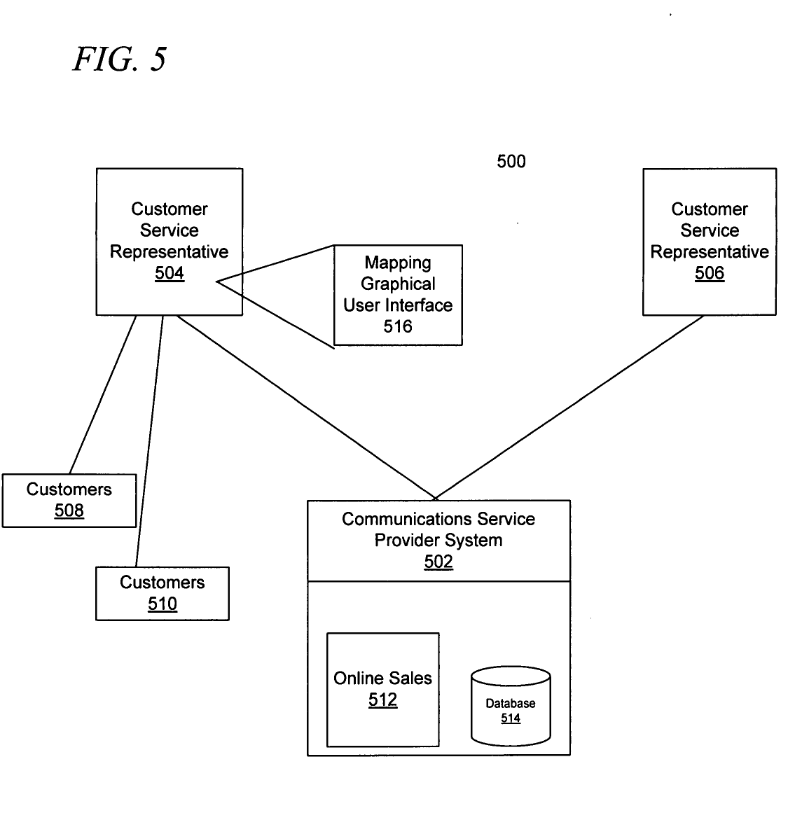

FIG. 5 is a block diagram of a geographic location system in accordance with an illustrative embodiment of the present invention. FIG. 5 provides a geographic location system 500. The geographic location system 500 may include various software and hardware components of a communications service network device all of which may not be illustrated in FIG. 5. As shown, geographic location system 500 includes communications service provider system 502, customer service representative 504 and 506, and customers 508 and 510. The communications service provider system 502 also includes online sales 512 and database 514. The customer service representative 504 further includes mapping graphical user interface 516.

The geographic location system 500 may be used by the customers 508 and 510 and customer service representatives 504 and 506 to identify the communications services that may be available to each customer 508 and 510 based on the geographic location of the customer or the customer's residence or business. The geographic location system 500 may also be used to determine where to launch new services and expand resources of the communications network based on information received from customers 508 and 510 and other potential customers that may be stored in database 514. The geographic location system 550 may also be used to specifically market and sale products and services, new and existing, to any number of customers 508 and 510 and potential customers using latitude and longitude points associated with their addresses.

Customers 508 and 510 are particular implementations of Customer A 108 and Customer B 110 of FIG. 1. The communications service provider system 502 provides the computing power, memory, and other resources that allow a customer service representative, such as customer service representative 504, to determine whether the customers 508 and 510 may have access to the services provided by the customer services provider. For example, the communications service provider system 502 may be a server, exchange, or other intelligent network device. The communications service provider system may display distance limitations of customers 508 and 510 and other potential customers which may include network distances and straight-line distances. Each customer 508 and 510 and potential customer may be geographically encoded with their information saved in the database 514 for

In one embodiment, the customer service representatives 504 and 506 may have access to communications service provider system 502 through a network connection. For example, the customer service representatives 504 and 506 may be located at a location remote to the customer service provider system 502. As a result, the customer service representative 504 may communicate with the communications service provider system 502 through a public or private network, such as the Internet or a dedicated network connection. The communications service provider system 502 includes online sales 512 that may be used to provide the customer service representatives 504 and 506 with sales information, prices, and other data that may be necessary to add, modify or delete services for the customers 508 and 510. The communications service provider system 502 may be connected to the network resources of the communications network allowing modifications, data, and other information to be easily sent and received.

The database 514 stores information regarding the services provided by the communications service provider. The database 514 may store geographic information, service availability maps, population and demographic information, network device locations, footprint maps, potential customers, addresses, and other information that is used by the communications service provider system 502 to both provide and administer the communications services that are provided to customers 508 and 510.

The database 514 may also be used to store and update customer information for when customers move. For example, if the communications service provider receives a request to terminate service due to an upcoming move, the new address may be used to determine available services and transfer or upgrade the services provided to the customer during the move. The database may also store a list of potential customers that have requested a particular service, but are unable to receive the service based on the current network configuration. For example, such potential customers may be targeted as “serviceable” for determining future network expansion. In another example, potential customers may sign an agreement agreeing to sign up for communications services expanded by the communication service provider to reach their area added. Alternatively, customer surveys may be used to determine if a potential customer would be interested in communications services in their area if they became available. As a result, a network may be purposefully overbuilt for future capacity and appropriately expanded based on demand. The potential customer information may specify services the potential customer is interested in, address and corresponding latitude and longitude, contact information, and other preferences and service information that may be used in the future.

The customer service representatives 504 and 506 represent the persons and/or devices providing user information to customers 508 and 510. The customer service representative 504 uses the mapping graphical user interface 516 to view the customer's geographic location by latitude and longitude, and also to determine the availability of services based on the physical location, available network devices, and other factors that may not be automatically evaluated. The mapping graphical user interface 516 may be part of the communications service provider system 502 or may be a separately executed application that allows the customer service representative 504 to determine the availability of services based on the physical location of the customer, service footprints the network distance, the straight line distance, or the distance to the nearest node or access point, and other routing data. The customers 508 and 510 may communicate with the customer service representative 504 through a network connection, such as an Internet website, a chat tool, a phone line, or other communications method. In one example, the customer 508 may call the customer service representative 504 using a cellular telephone. In another example, the customer 510 may go to the webpage of the communications service provider and request a chat session with the customer service representative 504 in order to initiate communication.

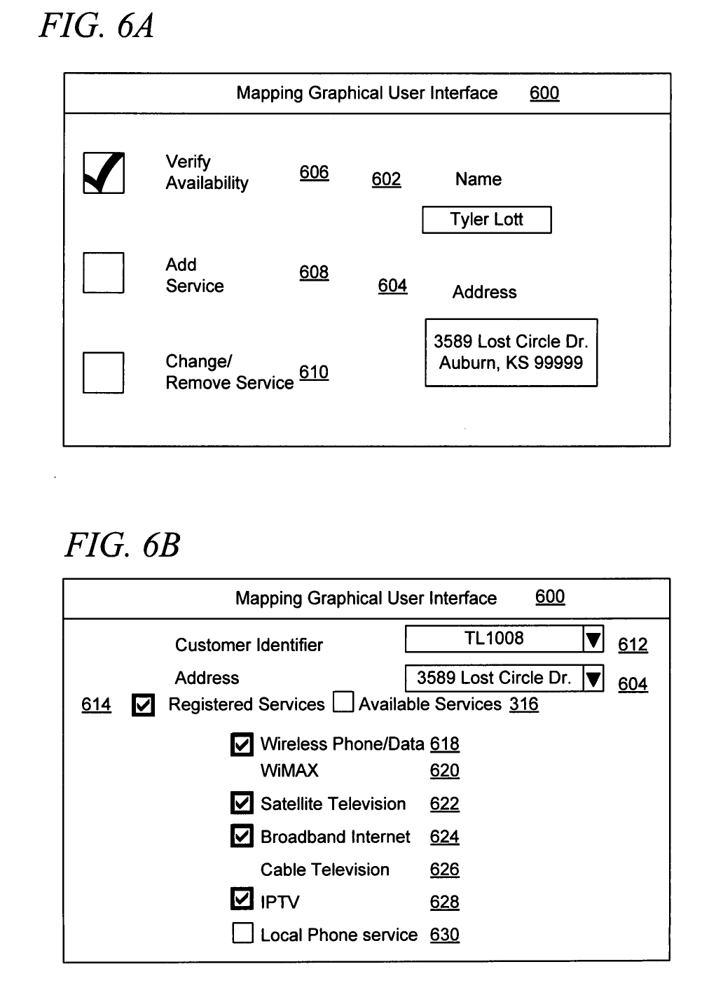

FIG. 6A is a mapping graphical user interface 600 in accordance with an illustrative embodiment of the present invention. FIGS. 6A and 6B are a particular implementation of the mapping graphical user interface 516 of FIG. 5. The mapping graphical user interface 600 may be displayed to a customer service representative on a computing device, such as a desktop computer, personal digital assistance, wireless device, or other data processing system. The mapping graphical user interface 600 may be part of a program application accessible to the customer service representative or provided from a communications service provider system. The mapping graphical user interface 600 may include any number of fields, icons, check boxes, data, or other means of displaying information and receiving user input from the customer service representative.

The mapping graphical user interface 600 may include a name 602, and an address 604, for allowing the customer's information to be input into the mapping graphical user interface 600. The name 602 and address 604 may be associated with a residence or business address of the customer. For example, the name 602 and address 604 may correspond to Customer A 108 of FIG. 1. In one embodiment, the mapping graphical user interface 600 of FIG. 6A allows a customer service representative to verify availability 606, add service 608, and change or remove service 610. The verify availability 606 may allow the customer service representative to determine whether the customer has access to services such as Customer A 108 of FIG. 1.

In other embodiments, the verify availability 606 may be used to determine the customer does not have access to services such as Customer B 110 of FIG. 1. The address 604 may be converted into a latitude and longitude address that is used to determine network and straight-line distances to the nearest network device or node. In the event that the customer is available to receive the services, the customer service representative may add services 608. Alternatively, the customer service representative may change or remove services 610 in accordance with the customer's needs. In the event the customer may not receive information the name 602 and address 604 may be stored in a database, such as database 514 of FIG. 5. This information may be used by the communications service provider for marketing, network expansion, or strategic planning.

The mapping graphical user interface 600 of FIG. 6B may be used to customize the services provided to the customer. Alternatively, the mapping graphical user interface 600 may be used to store preferences about a potential customer that may not be able to receive all of the services shown for future marketing and network expansion purposes. The mapping graphical user interface 600 includes a customer identifier 612 and the address 604, which may be used to identify the customer. The mapping graphical user interface 300 may further include registered services 614, available services 616, wireless phone/data 618, WiMAX 620, satellite television 622, broadband internet 624, cable television 226, Internet protocol television 628, and local phone service 630. In one example, the mapping graphical user interface 600 may show a field, box, or other icon indicating that there are available services 616, such as local phone service 630.

The registered services 614 may show an additional indicator that informs the customer service representative that the customer currently subscribes to the one or more services, such as wireless phone and data 618, satellite television 622, broadband internet, 624 and IP television 628. In addition, the mapping graphical user interface 600 may indicate the services that are not currently available, such as WiMAX 620, and cable television 626. As previously mentioned, the mapping graphical user interface 600 may be used by a customer service representative to individualize the services provided to the customer. In another embodiment, the mapping graphical user interface 600 may be displayed directly to the customer for allowing the customer to easily upgrade, modify or delete services as needed.

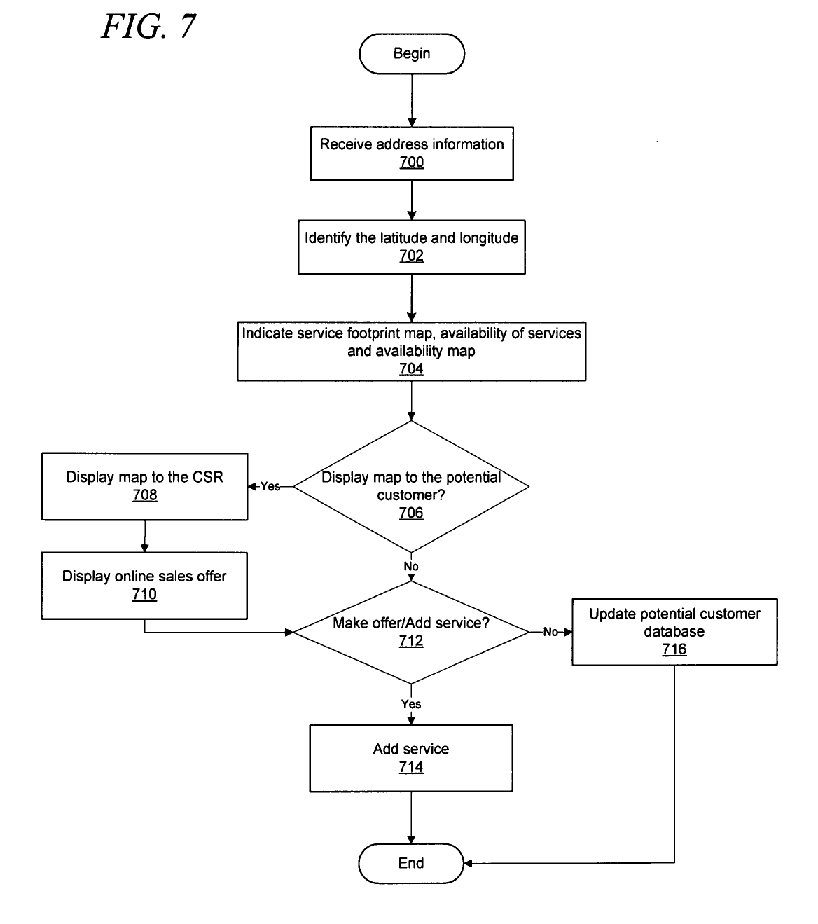

FIG. 7 is a flowchart of a process for geographic location through a customer service representative in accordance with an illustrative embodiment of the present invention. The process of FIG. 7 may be implemented when a customer service representative accesses a website or other graphical user interface and receives information and/or user input from a potential customer. The process begins by receiving address information (step 700). The address information may include the customer's current address, name, email address, and phone number.

The communications service provider system identifies the latitude and longitude (step 702). The latitude and longitude is identified in step 702 using any number of techniques, to map or otherwise determine the precise physical location of the customer. The latitude and longitude may be determined based on a mapping program or satellite mapping program that may accurately pinpoint the latitude and longitude of the customer. The latitude and longitude may be determined based on topographical maps of varying detail levels, such as city and neighborhood. The latitude and longitude may also be measured using a global positioning system (GPS) or GPS software. For example, a technician may go to the customer's address and take a latitude and longitude measurement. In another example, a database of latitude and longitude coordinates measured by GPS or otherwise may be used to determine the customer's latitude and longitude. The database may be part of a stand-alone program or network web application that determines latitude and longitude based on address, nearest intersection, proximity to landmarks, user input, or other parameters. The latitude and longitude may also be interpolated or circumstantially determined based on proximity to the nearest registered latitude and longitude point or other available information. By using an actual physical location measured by global positioning or other mapping systems there is no need to rely on information from the installation of twisted pair phone lines or cable connections. The latitude and longitude for different communications network resources may also be similarly determined. In one embodiment, as each network device is installed a GPS is used to pinpoint the latitude and longitude address for subsequent references.

Next, the communications service provider system indicates service footprint map, availability of services, and availability map (step 704). The different data displayed in step 704 may be used to determine the services available based on location and the footprint of the available services. The footprint map an availability map may be overlaid with the location of the customer's address to allow the customer and/or CSR to make informed decisions. The service footprint map may also include a proposed service map that may allow a user to specify whether he or she would be interested if the wireless service provider expanded to the latitude and longitude of the customer. As a result, the customer's contact information may be added to a call list or direct marketing campaign based on subsequent communications network expansions.

Next, the communications service provider system determines whether to display a map to the potential customer (step 706). The determination of step 706 may be made based on the different services that are available. If the customer service provider system determines to display the map to the potential customer, the communications service provider system displays the map to the customer service representative and potential customer (step 708).

Next, the communications service provider system displays online sales offers to the potential customer (step 710). The communications service provider system determines whether to make an offer or add a service (step 712). The determination of step 712 may be made based on user input or other user feedback indicating that the customer would like to modify a communications service, or become a new customer for services provided. If the communications service provider system determines not to display the map to the potential customer in step 706, the communications service provider system determines whether to make an offer and add a service (step 712). If the communications service provider system determines to make an offer or add a service, the service is added (step 714) with the process terminating thereafter.

If the communications service provider system determines not to make an offer or add a service in step 712, the communications service provider system updates a potential customer database (step 716) with the process terminating thereafter. The potential customer database may store information regarding customers that may be interested in signing up for a service that is currently unavailable based on their geographical location, or based on other mitigating factors or criteria. By updating a potential customer database, the communications service provider may be able to determine service trends and determine which areas may be most profitable for further expansion of communications services offered.

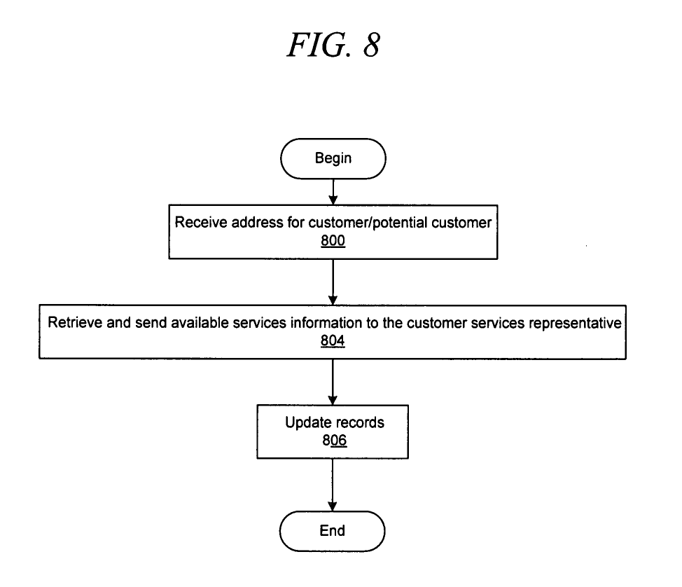

FIG. 8 is a flowchart of a process for updating a geographic location system in accordance with an illustrative embodiment of the present invention. The process of FIG. 8 may be implemented by a communications service provider system. The process begins by receiving an address for a potential customer (step 800). The communications service provider system may receive the address through voice or data communications.

Next, the communications service provider system retrieves and sends available services information to the customer service representative (step 802). The available services information may specify the services available to the customer based on the geographic location of the customer's residence or business location. In another embodiment, the available services information may be displayed directly to the customer through a graphical user interface.

Next, the communications service provider system updates records (step 806). The records may be updated based on newly provisioned, modified, or deleted services. Alternatively, the records may be updated in step 806 to represent potential customer information in the event the customer may not currently subscribe to the desired service or services.

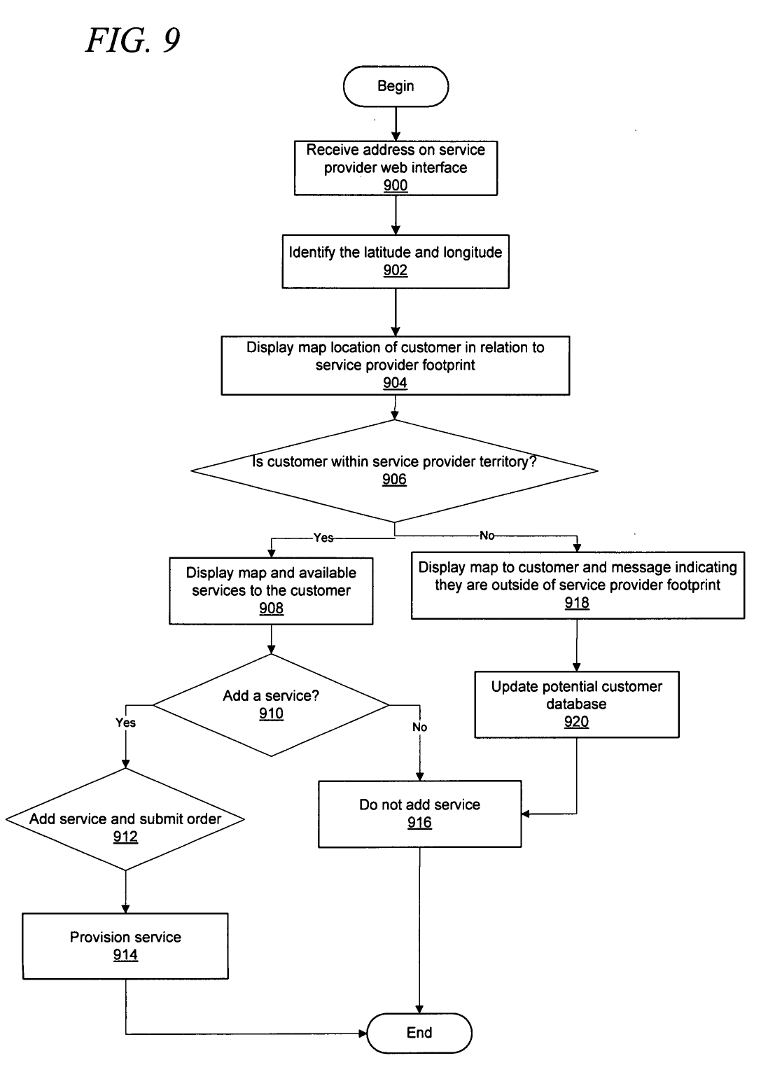

FIG. 9 is a flowchart of a process for geographic location through a website in accordance with an illustrative embodiment of the present invention. The process of FIG. 9 may be implemented by a website, graphical user interface or other program in communication with a communications service provider system.

The process begins by receiving an address on the service provider web interface (step 900). The address may be entered by a user using any number of standard user input devices, such as a keyboard, mouse, keypad, touch screen, or other input/output device. Next, the customer service representative identifies the latitude and longitude (step 902). The latitude and longitude may be determined based on the address previously entered. The customer service representative displays the map location of the customer in relation to the service provider footprint (step 904). The location of the customer may be the location that relates to the address specified in step 900. For example, the address may be linked to the residence or business of the customer.

Next, the customer service representative determines whether the customer is within the service provider territory (step 906). The determination may be made based on the service provider footprint displayed in step 904. If the customer is within the service provider territory, the customer service representative displays the map and available services to the customer (step 908). Next, the customer service representative determines whether to add a service (step 910). One or more services may be added in step 910, based on user input. For example, the user may verbally provide a confirmation to add a high speed Internet connection. If the customer service representative determines to add a service in step 910, the customer service representative adds the service and submits an order (step 912).

Next, the customer service representative provisions the service (step 914) with the process terminating thereafter. If the customer service representative determines not to add service, the service is not added (step 916). If the customer service representative determines the customer is not within the service provider territory in step 906, the customer service representative displays the map to the customer and a message indicating that they are outside of the service provider footprint (step 918). The information of step 918 may be displayed to the customer through a graphical user interface, or a chat tool, or verbally communicated to the customer over the telephone.

Next, the customer service representative updates a potential customer database (step 920), and does not add the service (step 916) with the process terminating thereafter. The potential customer database may be updated in step 920, in order to provide the communications service provider information with regard to potential customers and provide marketing and strategic expansion information. For example, the potential customer database may be used to determine locations in which potential customers exist so that the communications service provider may use future expansion and growth to cover those areas, thereby capturing more market share, and improving profitability.

The previous detailed description is of a small number of embodiments for implementing the invention and is not intended to be limiting in scope. One of skill in this art will envision the methods and variations used to implement this invention in other areas than those described in detail. The following claims set forth a number of the embodiments of the invention disclosed with greater particularity.

What is claimed:

1. A method for identifying potential customers for communications services, said method comprising:
identifying a latitude and longitude associated with an address of a potential customer;
indicating availability of the communication services based on the latitude and longitude;
displaying an availability map and service offers to the potential customer, and
adding a communication service for the potential customer.

2. The method according to claim 1, further comprising:
determining a latitude and longitude for a network device closest to the potential customer.

3. The method according to claim 1, calculating a network distance and a straight line distance between the latitude and longitude for the address and the latitude and longitude for the network device.

4. The method according to claim 1, wherein the indicating is performed based on the network distance, and the straight line distance.

5. The method according to claim 1, wherein the availability map indicates one or more footprints for communications services.

6. The method according to claim 1, further comprising:
updating a potential customer database in response to determining the communication service is unavailable for the potential customer.

7. The method according to claim 1, wherein indicating further comprises:
receiving the address for the potential customer, and
determining a network device that is closest to the address.

8. The method according to claim 1, wherein the receiving and adding are performed based on user input from the potential customer.

9. The method according to claim 1, wherein the user input is receiving using any of a website, chat tool, telephone, and graphical user interface.

10. The method according to claim 1, wherein the identifying, indicating, displaying, and adding are performed by a customer service representative with access to the computing resources of a communications service provider.

11. The method according to claim 1, further comprising:
updating records of a communications service provider.

12. The method according to claim 1, further comprising:
determining a number of potential customers in an area based on previous user requests for the communications services from the number of potential customers.

13. The method according to claim 12, further comprising:
expanding network resources to provide communication services to one or more areas based on the number of potential customers.

14. The method according to claim 12, further comprising:
marketing the communication services to the number of potential customers.

15. The method according to claim 12, further comprising:
displaying a revised availability map based on proposed additions to network resources.

16. A method for expanding communications resources, said method comprising:
identifying a plurality of potential customers that are unable to receive a communication service;
determining latitudes and longitudes associated with address of the plurality of potential customers;
determining a location for a network device that may provide the communication service to a portion of the plurality of potential customers based on the latitudes and longitudes;
installing the network device to provide the communication service to the portion of the plurality of potential customers; and
marketing the communications services to the plurality of potential customers.

17. The method according to claim 16, wherein one or more potential customers have requested the communication service and further comprising:
storing potential customer information regarding the one or more potential customers in response to determining the one or more potential customers are ineligible to add the communication service.

18. The method according to claim 16, further comprising:
surveying the plurality of potential customers to determine whether the plurality of customers is interested in adding the communication service in the future.

19. The method according to claim 16, further comprising:
notifying the portion of the plurality of customers that the communication service may be added.

20. A server for determining availability of communications services comprising:
a memory, wherein the memory includes a set of instructions; and
a processing unit connected to the memory for executing the set of instructions to identify a latitude and longitude associated with an address of a potential customer of a communication service provider, indicate availability of the communication services based on the latitude and longitude, display an availability map to the potential customer, and add a communication service for the potential customer.

21. The server according to claim 20, wherein the set of instruction further determines a latitude and longitude for a network device closest to the potential customer, calculates a network distance and a straight line distance between the latitude and longitude for the address and the latitude and longitude for the network device to determine availability of the communication services.

22. The server according to claim 20, wherein the set of instruction further updates a potential customer database in response to determining the communication service is unavailable for the potential customer.

23. The server according to claim 20, wherein the server communicates with a potential customer or customer service representative through a web interface to indicate the communications services that are available based on the address of the customer.
